(19) United States
(12) Patent Application Publication
(10) Pub. No.: US 2012/0250178 A1
(43) Pub. Date: Oct. 4, 2012

(54) MAGNETIC MEDIA WITH THERMAL INSULATION LAYER FOR THERMALLY ASSISTED MAGNETIC DATA RECORDING

(75) Inventors: Toshiki Hirano, San Jose, CA (US); Fu-Ying Huang, San Jose, CA (US); Jia-Yang Juang, Changhua (TW); Hal J. Rosen, Los Gatos, CA (US); Barry C. Stipe, San Jose, CA (US)

(73) Assignee: Hitachi Global Storage Technologies Netherlands B.V., Amsterdam (NL)

(21) Appl. No.: 13/077,797

(22) Filed: Mar. 31, 2011

(51) Int. Cl. G11B 5/02; G11B 5/673; G11B 5/66

(52) U.S. Cl. 360/59; 428/800; 428/846.4; G9B/5.026

(57) ABSTRACT

A magnetic media for heat assisted magnetic data recording. The magnetic media includes a thermal insulation layer structure formed near the substrate of the media provide more efficient heating of the write layer by allowing less heat dissipation to the substrate. The thermal insulation layer structure can be one or more layers of an oxide such as SiO2 and one or more layers of a material such as NiTa. Increasing the number of oxide layers and NiTa layers increases the thermal insulation of the thermal insulation layer structure thereby further increasing the efficiency of the heat assisted writing.

### FIELD OF THE INVENTION

The present invention relates to magnetic heads for data recording, and more particularly to a magnetic media having a thermal insulation layer for reduced energy consumption in thermally assisted data recording.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

A giant magnetoresistive (GMR) or tunnel junction magnetoresistive (TMR) sensor senses magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current there-through. The magnetization of the pinned layer is pinned perpendicular to the air bearing surface (ABS) and the magnetic moment of the free layer is biased parallel with the ABS, but free to rotate in response to external magnetic fields. The magnetization of the pinned layer is typically pinned by exchange coupling with an antiferromagnetic layer.

In a perpendicular magnetic recording system, the magnetic media has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

In order to optimize performance, the magnetic media must easily switch magnetization directions in response to a magnetic field from the write head. However, in order to be magnetically stable, these magnetizations must remain, even when the magnetic media is subjected to high temperature. This means that the magnetic media must have a high magnetic coercivity in order to prevent data loss. Such a media can, however, be difficult to write onto.

Thermally assisted recording can be used to overcome this problem, allowing data to be written onto a magnetically stable, high coercivity media. The media is heated, such as by a laser in order to temporarily lower the coercivity of the media while the data is being written. The media then cools, raising the coercivity to allow the media to be stable. In order to minimize the power consumption of the device, it is necessary that the heating be as efficient as possible. It is therefore, desirable to maximize heating efficiency to allow as little power consumption from the heating device (e.g. laser) as possible.

### SUMMARY OF THE INVENTION

The present invention provides a magnetic media for magnetic data recording that includes a substrate and a thermal insulation structure formed over the substrate. A low coercivity magnetic layer is formed over the thermal insulation layer, and a non-magnetic layer is sandwiched between the low coercivity layer and a magnetic write layer.

The present invention increases the efficiency of thermally assisted writing by greatly reducing the amount of heat that is lost to the substrate. This reduction in heat lost to the media substrate allows for reduced power consumption of the heating element.

Further insulation benefits can be achieved by increasing the number of oxide layers and NiTa layers in the thermal insulation structure. For example, the insulation structure can include three or four oxide layers with alternating NiTa layers.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an enlarged, cross sectional view of a portion of a magnetic media according to the prior art;

FIG. 3 is an enlarged, cross sectional view of a portion of a magnetic media according to an embodiment of the invention;

FIG. 4 is an enlarged, cross sectional view of a portion of a magnetic media according to an alternate embodiment of the invention;

FIG. 5 is a graph illustrating steady-state temperature along track center on a magnetic media;

FIG. 6 is a graph illustrating steady-state vertical temperature distribution in a magnetic media;

FIG. 7 is a graph illustrating steady-state temperature along a track center on media having different thermal barrier structures; and

FIG. 8 is a graph illustrating steady-state vertical temperature distribution in magnetic media having different thermal barrier structures.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

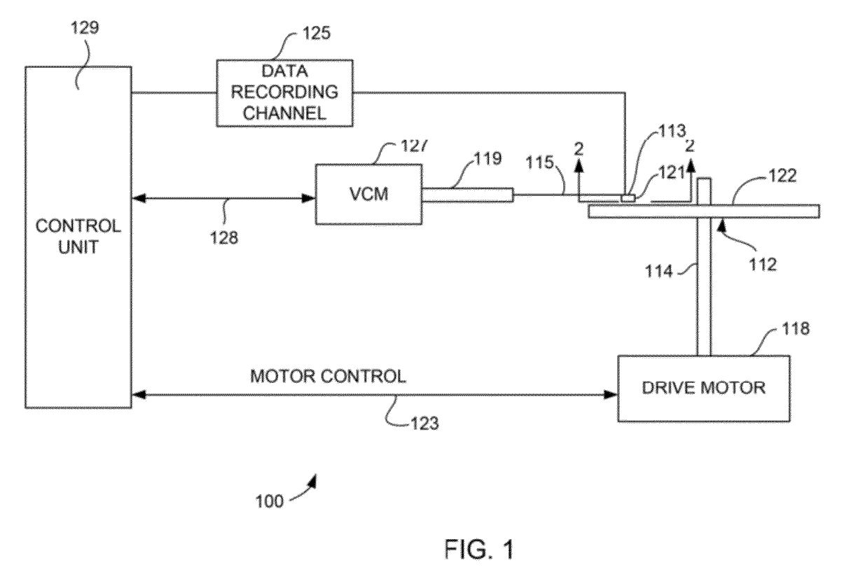

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, the slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

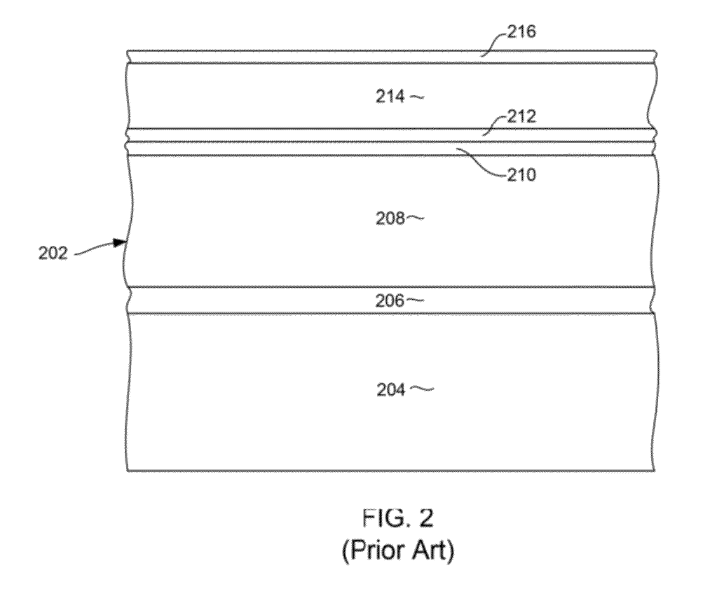

FIG. 2 shows an enlarged cross section of a magnetic media 112 such as might be used in a prior art perpendicular magnetic recording system. The media includes a substrate 204 which can be a smooth glass substrate or can be AlMg with NiP coating. A layer of NiTa can be formed over the substrate to provide an amorphous adhesion layer. A magnetically soft layer 208 is formed over the layer of NiTa 206. One or more non-magnetic de-coupling layers such as first and second Ru layers 210, 212 can be formed over the magnetically soft layer 208. The first Ru layer 210 is deposited in a relatively low pressure and the second Ru layer 212 at a relatively higher pressure. These layers 210, 212 initiate a desired grain structure in the layers deposited thereover. There may also be one or more additional layers between the layers 208 and 210. A magnetic recording layer 214 can be formed over the decoupling layers 210, 212, and a protective overcoat 216 can be formed over the magnetic recording layer 214.

As described above, thermally assisted magnetic recording can be used to increase the writeability of a high coercivity magnetic media. A heating device such as a laser (not shown in FIG. 2) can be used to locally heat a portion of the magnetic media 202 just prior to writing. One problem presented by such a system is that the substrate 204 may act as a very large heat sink to steal heat away from the recording layer 214 where it is actually needed. This is especially true for media that use NiP/AlMg substrates, such as are used in magnetic disks of most desktop and server disk drives. This presents at least a couple of problems. For one thing, this large heat sink increases the heat that must be supplied to heat the recording layer 214. This means that the heating element (e.g. laser, not shown) must consume a larger amount of power than would otherwise be necessary. This of course increases the power consumption of the computer or other device in which the recording system is being used and decreases the amount of time that the device can be operated on battery power.

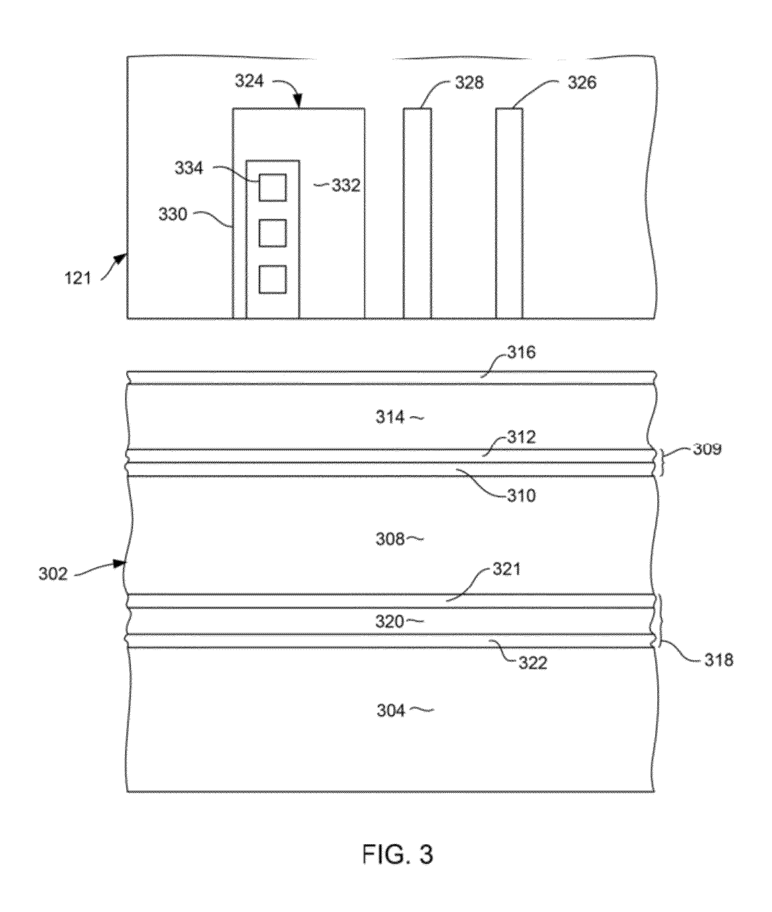

With reference now to FIG. 3, a magnetic media 302 according to an embodiment of the invention solves the above described problem. The media 302 includes a substrate 304 that can be a combination of NiP and AlMg or can be a glass substrate. A thermal insulation layer structure 318 is formed over and in contact with the substrate. The thermal insulation layer structure 318 includes a an adhesion layer 322, such as a layer of NiTa, formed over the substrate 304 and a dielectric layer 320, such as SiO₂, formed directly over the layer adhesion layer 322. The dielectrric layer 320 is preferably 50-150 nm thick or more preferably about 100 nm thick. In addition, another adhesion layer 321 of a material such as NiTa may be formed on top of the dielectric layer 320 to ensure that the above applied layers adhere well. This second adhesion layer layer 321 may be useful, because the soft magnetic layer 308 may not be able to stick well to an oxide layer 320 such as SiO₂.

A high permeability magnetic layer 308 is then formed on the thermal insulation layer 318. This magnetically soft layer 308 can be a material such as FeCoTaZr. A non-magnetic decoupling structure 309 can be formed over the magnetically soft layer 308. The decoupling layer 309 can be constructed as a pair of layers of Ru 310, 312. The lower Ru layer 310 is deposited at a relatively low pressure, whereas the upper Ru layer 312 is deposited at a relatively higher pressure. A high coercivity magnetic write layer 314 is formed over the decoupling structure 309. The magnetic write layer 314 is a high coercivity magnetic material such as (CoPtCr—SiO2 or Ll₀ FeNiPtAg—X where X is a segregant material such as an oxide, nitride, or carbide), that can maintain a stable magnetization after being magnetized by a writer 324.

The slider 113 described above with regard to FIG. 1, includes a magnetic head 326 has a magnetic writer 324, a read sensor 326 and a heating element 328. The writer includes a magnetic write pole 330, a magnetic return pole 332 and a write coil 334 that induces a magnetic write flux through the write pole 330, resulting in a magnetic write field being emitted toward the media 302. This magnetic write field locally magnetizes the layer 314 and then travels through the magnetically soft under-layer 308 to return to the return pole 332 where the magnetic field is sufficiently spread out and weak that it does not erase the previously recorded bit of data. The magnetic sensor 326, which can be a giant magnetoresistive (GMR) sensor or a Tunnel Junction Magetoresistive (TMR) sensor, reads the signal written by the writer 324.

As described above, in order for the magnetic media to be magnetically stable and maintain its magnetization over long periods of time and at high temperatures, the layer 314 must have a very high magnetic coercivity. While this high coercivity ensures that the magnetic signal written to the layer 314 will be magnetically stable, it also means that it is very hard to magnetize the layer 314. In order to make it easier to write to the magnetic layer 314, a heating element 328 is provided to locally heat the magnetic layer 314 just prior to writing. This heating element 328 is preferably a waveguide that can guide light from a laser to a desired point on the slider 121 for heating a portion of the disk 302. Alternatively, another heating device, such as a resistive heater, could be used to locally heat the disk.

In order to effectively assist in writing to the layer 314, the heating element 328 must heat the layer 314 to a high enough temperature to lower the magnetic coercivity of the layer 314. What's more, the layer 314 must remain at this high temperature until the write pole 330 has reached this location. As discussed above, in prior art systems the substrate 304 has provided a large heat sink which has quickly dissipated heat away from the layer 314. This has required a larger amount of heat to be generated from the heat source 328 in order to compensate for this heat sink effect. The excessive cooling caused by this heat sink effect causes the temperature of the layer 314 to drop quickly, requiring a larger heating from the heating element to ensure that the layer 314 is still hot enough when the write pole 330 reaches this location.

In the present invention however, the presence of the thermal insulation structure 318 prevents this heat sink effect by providing a thermal barrier between the layers 314, 308 and the substrate 304. This advantageously allows the magnetic write layer 314 to be heated to the necessary temperature with much less power consumption from the heating element 328. In addition, this also advantageously allows the layer 314 to remain at this elevated temperature for a longer duration, ensuring that this temperature is maintained when the write pole 330 passes over the heated location. The relative locations of the elements of the magnetic head 121 are for purposes of illustration, and can be arranged in other ways. For example, the heating element 328 could be located adjacent to the write pole 330, such as between the write pole 330 and return pole 332. In addition the write head 324 can include other elements not shown such as, but not limited to, a wrap-around trailing magnetic shield. These elements have not been shown in FIG. 3 for purposes of clarity.

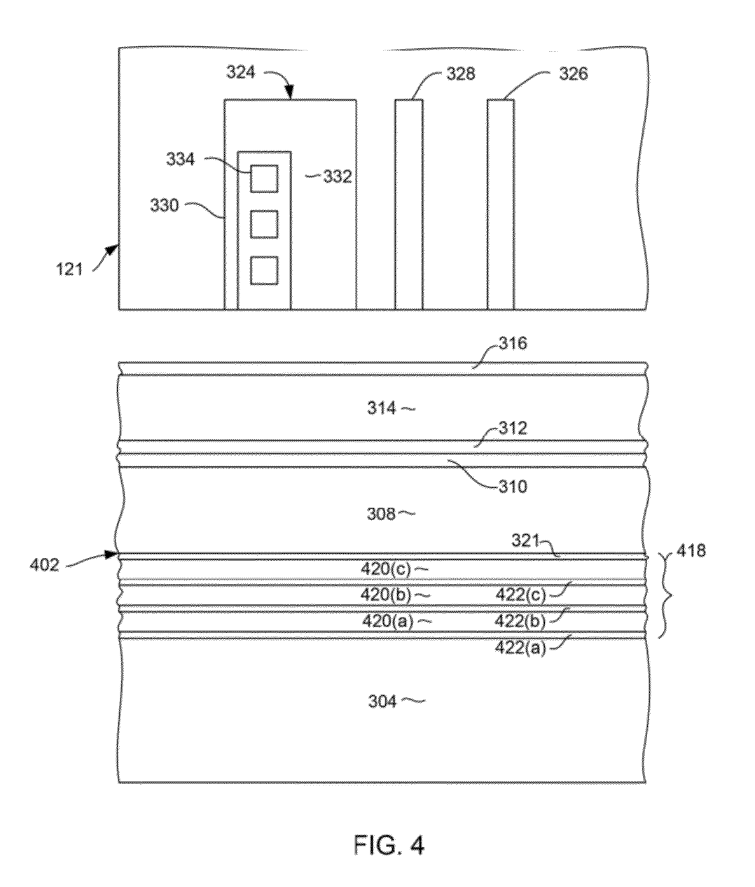

With reference now to FIG. 4, an alternate embodiment of the invention includes a thermal barrier layer 418 that has multiple interface layers. In this embodiment, the thermal barrier layer 418 includes multiple layers of a dielectric material 420(a), 420(b), 420(c) etc., such as SiO₂ each having an adhesion layer, constructed of a material such as NiTa, 422(a), 422(b), 422(c) there-beneath. Each interface between an adhesion layer 422 and an adjacent dielectric layer 420 provides an additional increase in thermal insulation of the thermal barrier layer 418. Therefore, while three dielectric layers 420 and three adhesion layers of 422 are shown in FIG. 4, this is by way of example, as the number of layers can be varied, and can include two or more such layers. As the number of layers 422, 420 increases, the thermal insulation of the structure 418 will increase accordingly. If a three layer structure is used as shown in FIG. 4, each of the dielectric layers 420 is approximately 10 nm to 100 nm thick, and each of the adhesion layers 422 is preferably 2-20 nm thick.

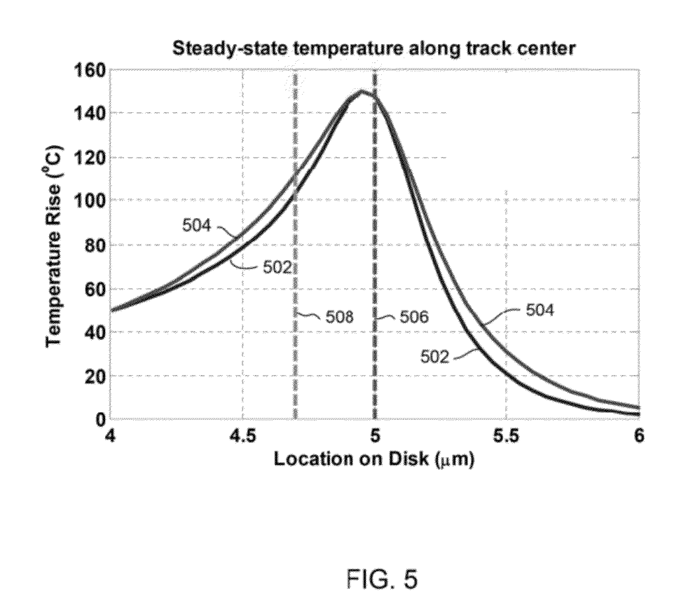

The benefits derived from the above described structures can be better understood with reference to FIGS. 5-7. FIG. 5 shows a temperature profile of steady-state temperature of a drive with respect to a location along a data track. Curve 502 shows the temperature profile for a media that does not incorporate the novel thermal barrier structure described above. Curve 504 shows the temperature profile for a magnetic media having a thermal barrier layer that includes a single dielectric layer with a thickness of 100 nm and a single adhesion layer. Line 506 indicates the location of a heating element disposed over the magnetic media and line 508 indicates the location of a magnetic write pole. As can be seen, the temperature drops off more slowly for the media having the thermal barrier layer. In fact, the temperature drop at the location of the write pole (508) is reduced by 17 percent for the media having the thermal barrier layer compared with the media having no thermal barrier layer.

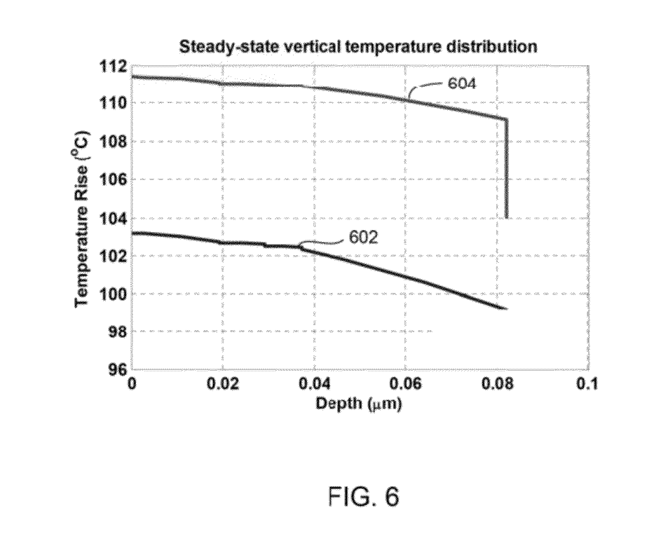

FIG. 6 shows the steady state temperature profile in the depth direction at the location of the write pole. The power delivered to the heater (326 in FIG. 3) has been adjusted to give the same peak power at the heat source for a prior art media and for a media having an insulation layer according to the invention. Curve 602 shows the temperature profile at the write pole location for a media having no thermal barrier layer. Curve 604 shows the profile for a media having a thermal barrier that includes 100 nm thick layer of SiO₂ above a NiTa layer, heated by the same heating source as that used for the media of curve 602. As can be seen, the media with the thermal barrier experiences a much lower temperature drop between the location of the heat source and the location of the write pole. It takes longer for the temperature to fall for the insulated media, allowing for much more efficient heat assisted writing

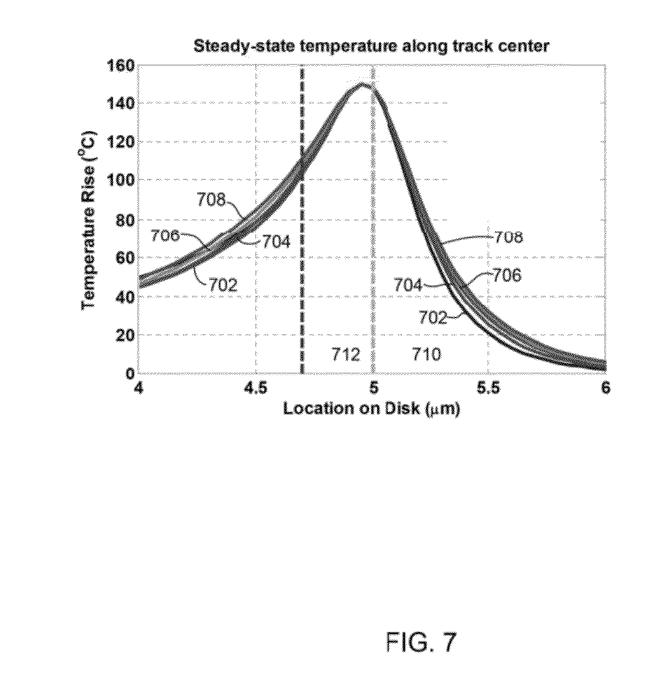

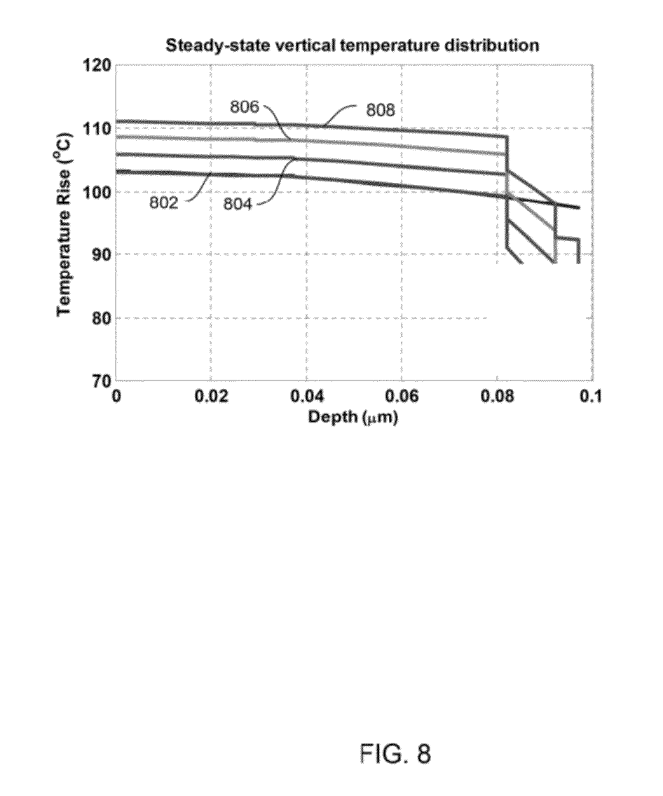

FIGS. 7 and 8 illustrate the benefits of using a multi-layer thermal barrier structure, such as the structure 418 of FIG. 4. FIG. 7 shows the steady-state temperature of a magnetic media along a data track for various thermal insulation structures. Curve 702 shows the steady state temperature for a media having a single layer thermal barrier structure such as the structure 318 of FIG. 3. Curve 704 represents a media having a thermal barrier layer with two dielectric layers and two adhesion layers. Curve 706 represents a media having a thermal barrier with three dielectric layers (of SiO₂) three adhesion layers (of NiTa), and curve 708 is for a media having four oxide layers and four adhesion layers. The line 710 represents the location of a heater element, and line 712 represents the location of a write pole. As can be seen from the graph the temperature drop at the write pole for a four layer thermal insulation structure is reduced by 17 percent compared with a structure having only a single layer thermal barrier layer structure or no thermal barrier layer at all.

FIG. 8 shows the steady state vertical temperature as a function of depth into the media. Curve 802 shows the temperature drop for a single layer thermal barrier structure such as the structure 318 of FIG. 3. Curve 804 shows the temperature drop for a two layer structure. Curve 806 shows the temperature drop for a three layer structure and curve 808 shows the temperature drop for a four layer structure. In each case, the power was adjusted to achieve the same peak temperature at the location of the heat source. There is a 34% drop in the power required to reach a given peak temperature at the location of the heat source for a four layer insulated media as compared with a media with a single layer of insulation or no insulation at all.

Therefore, it can be seen, that the novel media structure disclosed provides a very significant benefit in overall system performance, reducing the amount of power needed to heat a media to a sufficiently high temperature to assist in writing to the media. In addition, the provision of multiple layers and multiple interfaces in the structure further increase the thermal insulation. While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic media for magnetic data recording, comprising:
a substrate;
a thermal insulation structure formed over the substrate;
a high permeability magnetic layer formed over the thermal insulation layer;
a high coercivity magnetic write layer; and
a non-magnetic layer sandwiched between the high permeability layer and the high coercivity magnetic write layer.

2. The magnetic media as in claim 1 wherein the thermal insulation layer comprises an adhesion layer and a dielectric layer.

3. The magnetic media as in claim 2 wherein the dielectric layer comprises SiO₂.

4. The magnetic media as in claim 1 wherein the substrate comprises NiP and AlMg.

5. The magnetic media as in claim 1 wherein the substrate consists of NiP and AlMg and the thermal insulation layer comprises an adhesion layer and a dielectric layer.

6. The magnetic media as in claim 1 wherein the insulation layer comprises an adhesion layer formed directly on the substrate and a dielectric layer formed directly on the adhesion layer.

7. The magnetic media as in claim 1 wherein the insulation layer comprises an adhesion layer formed directly on the substrate and a layer of SiO₂ formed directly on the adhesion layer.

8. The magnetic media as in claim 1 wherein the insulation layer comprises a first layer of NiTa formed directly on the substrate, a dielectric layer formed directly on the first layer of NiTa and a second layer of NiTa formed directly on the dielectric layer.

9. The magnetic media as in claim 1 wherein the insulation layer comprises a first adhesion layer formed directly on the substrate, a dielectric layer formed directly on the first adhesion layer and a second adhesion layer formed directly on the dielectric layer.

10. A magnetic media for magnetic data recording, comprising:
a substrate;
a thermal insulation structure formed over the substrate, the thermal insulation layer comprising a plurality of dielectric layers and a plurality of layers of adhesion layers;
a high permeability magnetic layer formed over the thermal insulation layer;
a high coercivity magnetic write layer; and
a non-magnetic layer sandwiched between the high permeability layer and the magnetic write layer.

11. The magnetic media as in claim 10 wherein the plurality of dielectric layers and the plurality of layers of adhesion layers are arranged in an alternating fashion relative to one another.

12. The magnetic media as in claim 10 wherein the plurality of dielectric layers comprise layers of SiO₂.

13. The magnetic media as in claim 10 wherein the plurality of dielectric layers includes at least three dielectric layers.

14. The magnetic media as in claim 10 wherein the plurality of dielectric layers includes at least three dielectric layers each dielectric layer being sandwiched between a pair of adhesion layers.

15. The magnetic media as in claim 10 wherein the plurality of dielectric layers includes at least four dielectric layers.

16. The magnetic media as in claim 10 wherein the plurality of dielectric layers includes at least four dielectric layers, each dielectric layer being sandwiched between a pair of adhesion layers.

17. The magnetic media as in claim 10 wherein the thermal insulation layer consists of:
a first layer of NiTa formed directly on the substrate;
a first layer of SiO₂ formed directly on the first layer of NiTa;
a second layer of NiTa formed directly on the first layer of SiO₂;
a second layer of SiO₂ formed directly on the second layer of NiTa;
a third layer of NiTa formed directly on the second layer of SiO₂;
a third layer of SiO₂ formed directly on the third layer of NiTa; and
a fourth layer of NiTa formed directly on the third layer of SiO₂.

18. The magnetic media as in claim 10 wherein the thermal insulation layer consists of:
a first layer of NiTa formed directly on the substrate;
a first layer of SiO₂ formed directly on the first layer of NiTa;
a second layer of NiTa formed directly on the first layer of SiO₂;
a second layer of SiO₂ formed directly on the second layer of NiTa;
a third layer of NiTa formed directly on the second layer of SiO₂;
a third layer of SiO₂ formed directly on the third layer of NiTa;
a fourth layer of NiTa formed directly on the third layer of SiO₂;
a fourth layer of SiO₂ formed directly on the fourth layer of NiTa; and
a fifth layer of NiTa formed directly on the fourth layer of SiO₂.

19. The method as in claim 10 wherein the substrate comprises NiP and AlMg.

20. A magnetic data storage system, comprising:
a magnetic media;
a slider having a magnetic head thereon that includes a read sensor a magnetic writer and a heating element; and
an actuator connected with the slider to move the slider adjacent to a surface of the magnetic media;
wherein the magnetic media comprises:
a substrate;
a thermal insulation structure formed over the substrate;
a high permeability magnetic layer formed over the thermal insulation layer;
a high coercivity magnetic write layer; and
a non-magnetic layer sandwiched between the high permeability layer and the magnetic write layer.
